(19) United States
(12) Patent Application Publication
(10) Pub. No.: US 2017/0055067 A1
(43) Pub. Date: Feb. 23, 2017

(54) THIN HIGH PERFORMANCE CONSTANT DIRECTIVITY WAVEGUIDE AND SPEAKER

(71) Applicant: Harman International Industries, Incorporated, Stamford, CT (US)

(72) Inventors: Jerry MORO, Moorpark, CA (US); Charles M. SPRINKLE, Ventura, CA (US)

(21) Appl. No.: 15/236,720

(22) Filed: Aug. 15, 2016

Related U.S. Application Data
(60) Provisional application No. 62/207,294, filed on Aug. 19, 2015.

(51) Int. Cl. H04R 1/28; H04R 1/02

(52) U.S. Cl. CPC H04R 1/2861; H04R 1/026; H04R 2201/021

(57) ABSTRACT

A loudspeaker includes a horn and a compression driver in a shallow package for installation in a wall, e.g., a four inch wide wall. The total depth for this loudspeaker may be about 3 and ¾ inches. A low frequency speaker can be supported by the frame and dimensioned to be mounted in a wall. The horn can be supported by the frame positioned by the speaker. A compression driver is supported by the frame and acoustically connected to the horn. The horn acoustically loads the compression driver to provide a high dynamic output and a high sound pressure level with controlled acoustic directivity.

### CROSS-REFERENCE TO RELATED APPLICATIONS

This application claims the benefit of U.S. provisional application Ser. No. 62/207,294 filed Aug. 19, 2015, the disclosure of which is hereby incorporated in its entirety by reference herein.

### TECHNICAL FIELD

The present disclosure relates to loudspeakers and, more specifically, to wall mounted loudspeakers and their components.

### BACKGROUND

Wall mounted speakers introduce challenges due to the relatively narrow depth of walls.

### SUMMARY

A loudspeaker for mounting in a wall is described. The loudspeaker can include a frame dimensioned to be mounted in a wall with a front face being flush mounted to the wall with a speaker supported by the frame and dimensioned to be mounted in a wall and a horn supported by the frame positioned by the speaker. A compression driver is supported by the frame and acoustically connected to the horn. The horn acoustically may load the compression driver to provide a high dynamic output and a high sound pressure level with controlled acoustic directivity.

In an example, the horn is configured to provide a constantly controlled timbre and a uniform sound pressure level in a room at least partially defined by the wall in which the frame is mounted with the horn and the speaker acoustically facing outwardly into the room.

In an example, the speaker is a woofer to broadcast low frequencies.

In an example, the horn and the compression driver broadcast non-low frequencies without equalization of the low frequencies.

In an example, the frame and the horn have a combined depth less than a depth of the wall in which the frame is mounted.

In an example, the frame includes a brace extending from a first side of the frame to a second side of the frame between the speaker and the horn.

In an example, the brace includes apertures therein acoustically joining a first frame volume adjacent the speaker and a second frame volume adjacent the horn and the compression driver.

In an example, the frame includes a rear subframe to close a rear of the frame, an intermediate subframe connected to the rear subframe and a front subframe connected to the intermediate subframe. The horn may be mounted on the front subframe and extends rearwardly within the intermediate subframe and ends before the rear subframe.

In an example, the front face of the frame includes an aperture at which the speaker is mounted to provide an acoustical path out of the loudspeaker.

In an example, the horn extends partially past the aperture.

In an example, the horn includes a curved surface that extends past the aperture.

In an example, the horn includes a rectangular periphery.

A wall mountable loudspeaker may include a frame dimensioned to be mounted in a wall with a front face being flush mounted to the wall, a first speaker supported by the frame and dimensioned to be mounted in a wall, a second speaker supported by the frame and dimensioned to be mounted in a wall, the second speaker being positioned laterally aligned, and a horn supported by the frame positioned longitudinally by the first speaker and the second speaker. A compression driver supported by the frame and acoustically connected to the horn. The horn may acoustically load the compression driver to provide a high dynamic output and a high sound pressure level with controlled acoustic directivity. In an example, the horn is configured to provide a constantly controlled timbre and a uniform sound pressure level in a room at least partially defined by the wall in which the frame is mounted with the horn and the speaker acoustically facing outwardly into the room.

In an example, the first speaker and the second speaker are tilted radially outwardly from each other.

In an example, the horn faces directly outwardly from the front face of the frame.

In an example, the horn is configured to direct sound above about 1 kHz.

In an example, the frame and horn have a depth less than a depth of the wall in which the frame is mounted.

In an example, the frame includes a brace extending from a first side of the frame to a second side of the frame between the horn and the first and second speakers.

In an example, the front face includes a first aperture aligned with the first speaker and a second aperture aligned with the second speaker to provide acoustically access through the front face, and wherein the horn includes a side that extends at least partially past the first aperture and the second aperture.

In an example, the front face of the frame includes a center port to receive a fastener to fix the frame in a wall, the center port being positioned between the horn, the first speaker and the second speaker.

In an example, the horn includes a rectangular periphery defined by a curved surface with a portion of the rectangular periphery extending through the first aperture and the second aperture.

In an example, the horn and the frame are integrally formed.

### BRIEF DESCRIPTION OF THE DRAWINGS

FIG. 1 shows a front perspective view of a loudspeaker according to an example embodiment.

FIG. 2 shows a rear perspective view of a loudspeaker according to an example embodiment.

FIG. 3 shows a front elevational view of a loudspeaker according to an example embodiment.

FIG. 4 shows an exploded view of a loudspeaker according to an example embodiment.

FIG. 5 shows a front perspective view of a loudspeaker according to an example embodiment.

FIG. 6 shows a rear perspective view of a loudspeaker according to an example embodiment.

FIG. 7 shows an exploded view of a loudspeaker according to an example embodiment.

FIG. 8 shows a front perspective view of a mounted loudspeaker according to an example embodiment.

FIG. 9 shows a rear perspective view of a mounted loudspeaker according to an example embodiment.

FIG. 10 shows a view of a horn according to an example embodiment.

FIG. 11 shows a rear perspective view of the loudspeaker according to an example embodiment.

FIG. 12 shows a side, rear perspective view of the loudspeaker according to an example embodiment.

FIG. 13 shows a vertical cross sectional view of the loudspeaker taken generally along line 13-13 of FIG. 11 according to an example embodiment.

FIG. 14 shows a horizontal cross sectional view of the loudspeaker taken generally along line 14-14 of FIG. 11 according to an example embodiment.

FIG. 15 shows an exploded view of a loudspeaker according to an example embodiment.

FIG. 16 shows a rear perspective view of the face plate according to an example embodiment.

FIG. 17 shows an enlarged front view of a loudspeaker according to an example embodiment.

FIG. 18 shows a cross sectional view of a loudspeaker according to an example embodiment.

FIG. 19 shows a rear view of a face plate for a loudspeaker according to an example embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present description describes a shallow package suitable for in-wall mounting. The shallow package is a complete loudspeaker package comprising an ultra-shallow constant directivity horn coupled with an ultra-shallow professional compression driver for a total depth less than a typical wall, e.g., less than 3¾″. The present loudspeaker may provide: a constant controlled directivity for uniform timbre and sound pressure level (SPL) throughout the room defined by the walls; the high dynamic SPL capability being obtained a compression driver; a loudspeaker without a need for equalization up to 10 kHz and beyond; and capable of being mounting in a standard 4″ stud wall. The horn acts to acoustically load the compression driver so that the compression driver produces undistorted sound at the lower frequencies of the compression driver's usable operational bandwidth.

The present market has experienced significant demand for high end home theater systems and professional recording, mixing and mastering facilities, for loudspeakers with high SPL output, low distortion and constant directivity that are shallow and which could be mounted in a U.S. standard 4 inch depth wall or other standard interior wall depths. The use of a compression driver and a horn matched to acoustically load the compression driver are packaged together in a shallow loudspeaker to provide a high dynamic output and high sound pressure level with controlled acoustic directivity. Conventional loudspeakers require multiple high frequency transducers to offer some of these performance characteristics. The present loudspeaker is different from conventional in-wall speakers that may have an unmatched waveguide in that such waveguides are low technology waveguides placed in front of conventional cone/dome transducers which do not have the dynamics of a true professional compression driver. Such wave guides in some instances are purely added for appearance with little to no beneficial acoustic performance. Many transducers do not require a horn or wave guide to produce sounds. The conventional in-wall solutions have inconsistent directivity associated with distorted timbre, low dynamic capability, do not fit in a 4 inch depth, and/or have a restricted main listening area that requires “aiming” the speaker, which may be difficult in home installations, e.g., non-acoustic professional installation. These current technologies are not acceptable and the market desires a better solution.

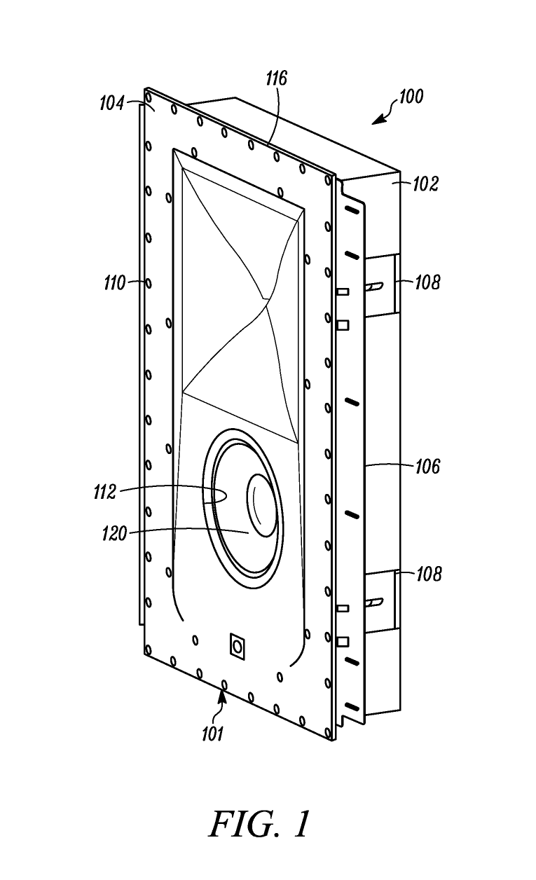

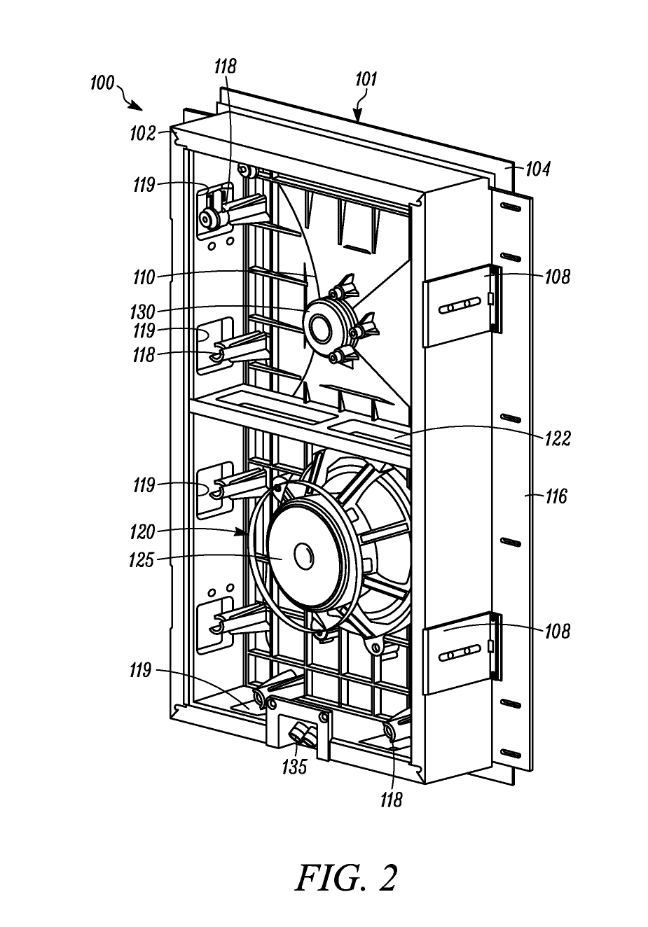

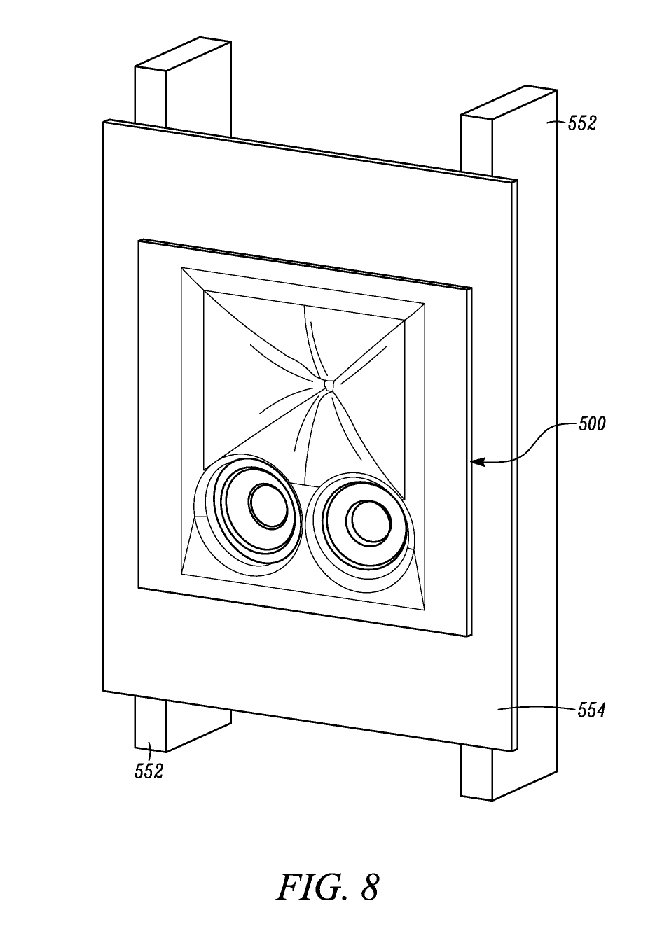

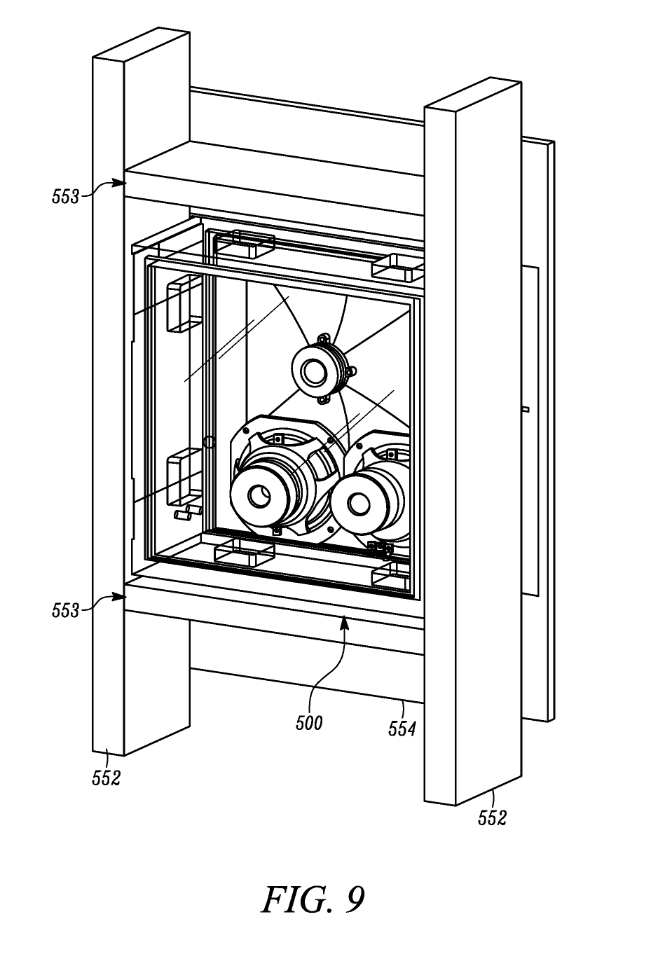

FIGS. 1 and 2 show a front perspective view of a loudspeaker 100 that has an enclosure 101 formed to fit within an interior wall. The interior wall may be an interior wall or a non-load bearing wall of a dwelling or a recording studio, e.g., a stud frame wall, a wall formed by 2×4s and similar constructions. The enclosure 101 comprising a rear enclosure 102 and a face plate 104. The enclosure may be 3.5-inch/90 mm deep to fit in interior walls. The rear enclosure 102 may be a box, in a hollow polygonal shape such as a cube or cuboid defined by walls 142 (FIG. 2). A faceplate 104 can be affixed to the rear enclosure 102. The face plate 104 includes an outer rectangular portion surrounding a horn 110 and a speaker opening 112. The rectangular portion includes a perimeter lip 116 configured to engage a wall and support a cover screen (not shown). The rear enclosure 102 includes a first subframe 144 (FIG. 2) that has connectors 106 to lay over the walls 142 with a plurality tab connectors 108. A second subframe 146 (FIG. 2) connects the face plate 104 to the enclosure 101 via the first subframe 144. In an example, the second subframe 146 may be a gasket, e.g., a rubber gasket, a foam gasket, a paper gasket or the like. The second subframe 146 may act to reduce vibration from the loudspeaker to the wall, e.g., vibration to the wall board 554 as shown in FIGS. 8 and 9. The wall board may be intermediate the first subframe 144 and the second subframe 146 when mounted to a wall. A speaker 120 is mounted to the speaker opening 112. The speaker 120 may be a low frequency speaker, e.g., a woofer.

In an example, the compression driver 130 may be a one-inch/25 mm annular ring diaphragm compression driver. The compression driver may include a metal film or a composite film that is driven by a wire coil between coils of a magnet. The compression driver may include a polyethylene-naphthalate (PEN) film as the diaphragm.

In an example, the rear enclosure 102 can include a wood construction to be positioned behind drywall and provides optimized acoustic performance.

The horn 110 may include an entrance disposed at a first axial end of the horn and configured to receive a driver. A mouth may be disposed at a second axial end of the horn 110 opposite the entrance. A contoured surface may extend between the entrance and the mouth. A cross sectional shape of a coverage pattern of audible sound emitted by the loudspeaker 100 coupled with the horn may be independent of a shape of the entrance and a shape of the mouth. The horn 110 may define the coverage pattern of the loudspeaker in one or more planes. The horn 110 acts as a waveguide for the acoustic waves emitted by the associated compression driver. The horn 110 includes an entrance, which may be positioned at a first axial end thereof. The entrance may be positioned on an entrance plane that is perpendicular to a longitudinal axis of the horn 110. The longitudinal axis may be a line that is perpendicular to the entrance plane and intersects the entrance plane at the center of the entrance. The horn 110 may or may not be symmetrical about the longitudinal axis. The entrance may be configured to receive a compression driver. The horn 110 may include a mouth disposed at a second axial end thereof, opposite the entrance. The horn 110 may include a contoured surface extending between the entrance and the mouth. The contoured surface may be an inner surface defining a cavity within the horn or waveguide. The contoured surface may include, for example, a frusto-conical surface or a plurality of walls arranged relative to one another to from the cavity. The walls may have differing curvature. The horn 110 may include a throat extending between the entrance and the contoured surface. For example, the contoured surface may have a first axial end positioned near the entrance and a second axial end positioned near the mouth. The throat may extend from the entrance to the first axial end of the contoured surface to couple the contoured surface to the entrance. The throat may be configured as a tubular member defined by one or more walls. In one example, the cross sectional area of the throat transverse to the longitudinal axis of the horn may expand along the longitudinal axis of the horn. For example, the cross sectional area of the throat may expand exponentially. In other examples, the cross sectional area of the throat may remain substantially constant, contract, or any combination thereof. In an example, the term “horn” may include any form of mechanism or device having an entrance and a mouth that can be placed the vicinity of a loudspeaker to affect or modify the directivity or pattern of at least a portion of audible sound waves produced by the loudspeaker, e.g., the compression driver.

FIG. 2 shows a rear perspective view of the loudspeaker 100. A compression driver 130 is mounted to the throat of the horn 110. The compression driver 130 is loaded by the horn 110, even though the horn 110 is a shallow horn. Loading allows the compression driver 130 to efficiently produce low end frequencies, e.g., down to the frequencies being produced by the speaker 120. The speaker 120 may be a woofer or a midrange or both speaker. The speaker 120 may include a seven-inch/180 mm driver. The speaker 120 may be a cast-frame, advanced aluminum matrix cone woofer with neodymium low-distortion motor structures.

A brace 122 is positioned intermediate the two ends of the rear enclosure 102. In the illustrated example with a cuboid rear enclosure 102, the brace 122 is positioned along the minor axis of the rear enclosure. The brace 122 may be solid, e.g., wood, polymer or metal, or may have apertures to reduce weight. The brace 122 helps keep the enclosure 122 rigid. In an example, the brace 122 is positioned an interior edge of the horn 110 and intermediate the compression driver 130 and speaker driver 125. The brace 122 may include a connection feature to mate with a connector of the front face plate 104. The connection feature may be an opening to receive a connector or a clamp interface. The brace 122 when fixed to the front face plate 104 can also act to dampen vibration of the front face plate 104, which forms the horn and to which the speaker 125 is mounted. In an example, the brace connector is a female connector part to receive a male connector part on the front face plate. The brace connector part may be the male connector and the face plate connector part may be the female connector. The connector parts can be connected by threads, press fit, bayonet fit, detent fit, adhesive and similar connection means.

An audio connector 135 is mounted to the bottom of the rear enclosure 102 and is electrically connected to the compression driver 130 and speaker 120, e.g., through wires and crossover circuitry. Other audio conditioning circuits may be intermediate the audio connector 135 and the speaker 120 and compression driver 130. However, the audio connected 135 may be positioned at the top of the rear enclosure 102. In an example embodiment, the audio connector 135 is mounted adjacent the speaker 120 and is remote from the compression driver 130.

A plurality of biased or adjustable leg connectors 118 extend rearwardly from the face plate 104 to fixedly engage recessed pockets 119 in the rear enclosure 102. The leg connectors 118 may be integrally molded with the face plate 104. In an example, the face plate 104 and leg connectors 118 may be a polymer. An additional center positioned leg clamps the center stiffening member, e.g., a brace or bracket 122 to secure the front face plate 104 to assist in eliminating structural vibration of the face plate 104 and thus elimination of undesirable extraneous resonances, vibrations and noises. In another example, a center hole in the faceplate allows the use of extended length screw through an extended hollow shaft to clamp and secure the front plate 104 to the rear of the enclosure 102 for same reasons of reduced vibration and noises.

The tab connectors 108 may be press fit against the outer wall of the rear enclosure 102 to fix the first subframe 144 to the rear enclosure 102.

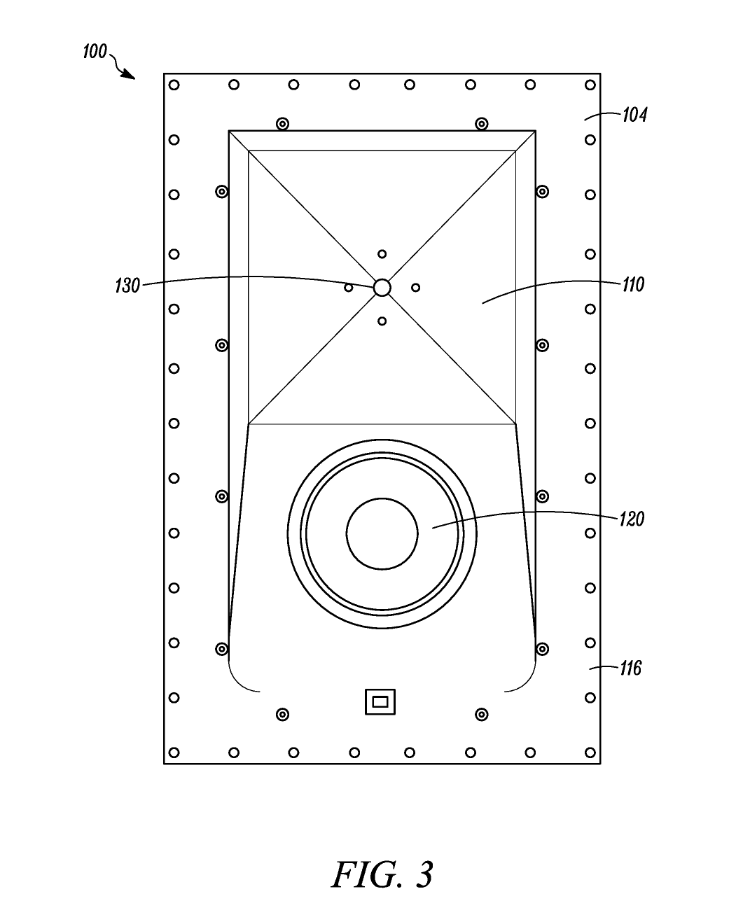

FIG. 3 shows a front elevational view of the loudspeaker 100 with the horn 110 vertically aligned with the speaker 120.

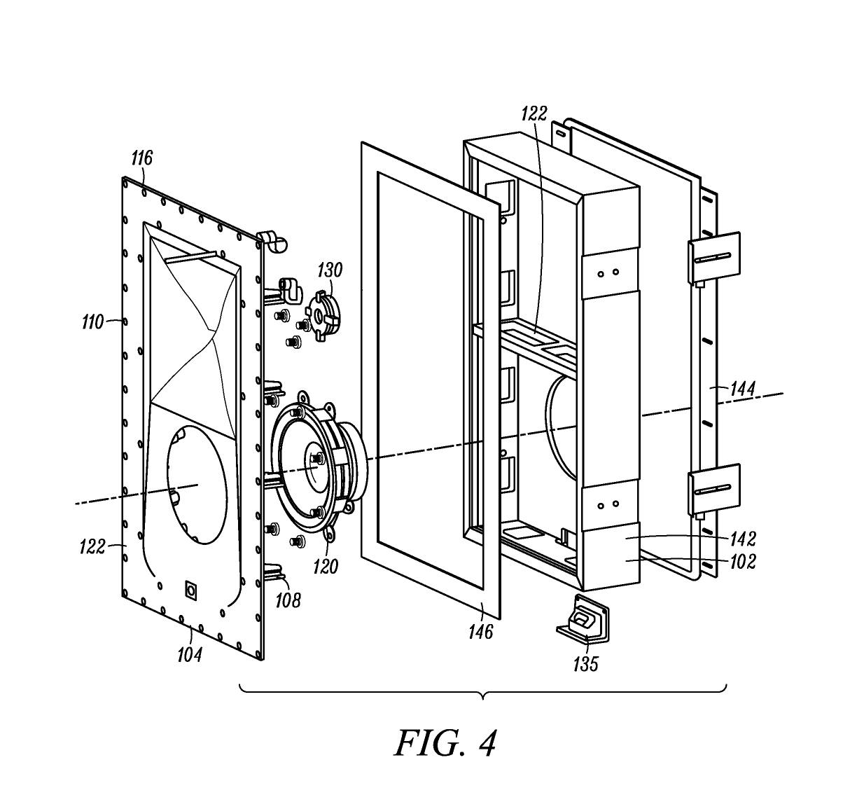

FIG. 4 shows an exploded view of the loudspeaker 100 with the faceplate 104, the compression driver 130, a speaker 120, a second subframe 146, the enclosure 102, the audio connector 135 and the first subframe 144.

The horn 110 can have a rectangular outer periphery that is dimensioned to be 250 mm by 350 mm. Smaller dimensions may be used, for example, 250 mm, +/−25 mm or +/−50 mm. The horn 110 depth can be less than 50 mm. In an example, the horn depth is about 45.9 mm, +/−0.2 mm. It will be appreciated that the speaker opening 120 does not extend into the horn 110.

The horn 110 may be a high definition imaging (HDI) geometry horn. The horn 110 as described herein may be configured to provide a substantially predefined coverage angle or direction of sound waves in any plane intersecting the horn axis (e.g., the longitudinal axis). The predefined coverage angles in a plurality of different planes each including the horn axis may collectively define a predefined coverage pattern of sound waves provided by the horn 110. The coverage pattern of sound waves may be substantially predefined without regard to the horn shape, which may enable independence between the horn shape and the coverage pattern. Any suitable method of horn profile geometry design may be applied to an arbitrary number of oblique planes to provide the horn 110 configured to provide a defined coverage pattern of sound waves in the oblique planes all while acoustically loading the compression driver. In one example, the contoured surface may be configured such that the coverage pattern of sound waves produced by the loudspeaker 100 may be defined in each of a plurality of oblique planes. The transitions between sections may be blended to reduce diffraction. For example, the contoured surface of the horn 110 may taper continuously from one design plane to an adjacent design plane to reduce diffraction. In this manner, the coverage pattern may be independent of the shape of the horn (e.g., the shape of the entrance and/or the mouth). The coverage pattern, which may be formed from a combination of coverage angles in the plurality of planes, may be rectangular, elliptical, or any other shape. For example, an elliptical horn may produce an elliptical coverage pattern, an elliptical horn may produce a rectangular coverage pattern, a rectangular horn may produce an elliptical coverage pattern, a rectangular horn may produce a rectangular coverage pattern, or an amoeba shaped horn may produce a trapezoidal coverage pattern. In other examples, a horn 110 having any shape may produce a coverage pattern having any shape. Because the horn 110 may be configured to provide a desired coverage pattern of audible sound waves in the plurality of design planes (e.g., design planes in addition to horizontal and/or vertical planes), the frequency response and/or directivity anomalies of sound waves produced by the loudspeaker 100 may be reduced as compared to horn designs with less than three design planes. Because horn geometry may be defined from the central horn axis outward, internal reflections may be reduced and/or frequency response may be improved as compared to horn designs with less than three design planes.

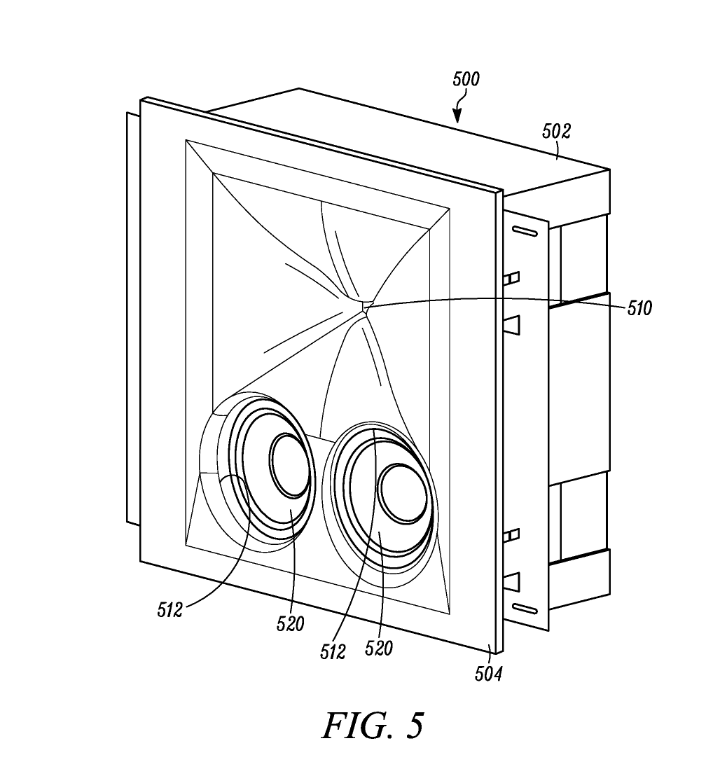

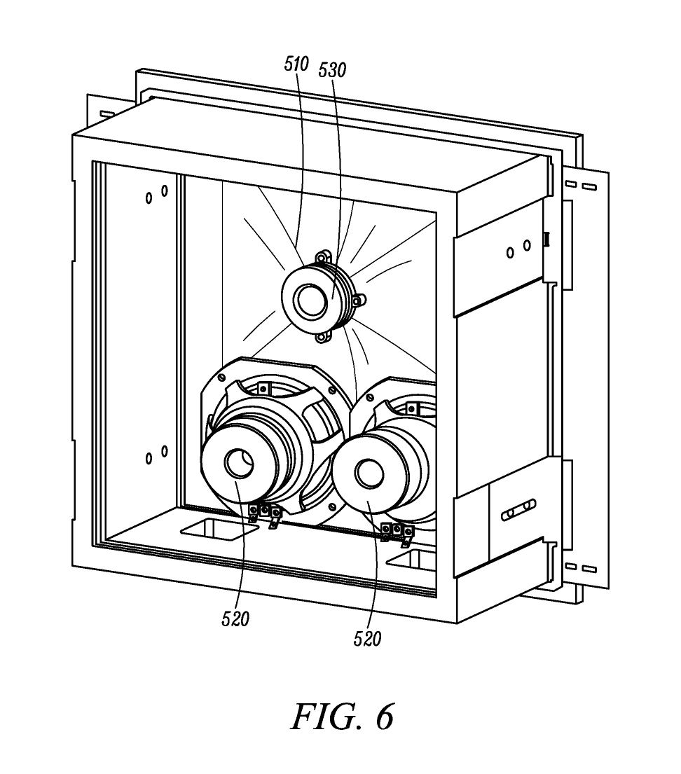

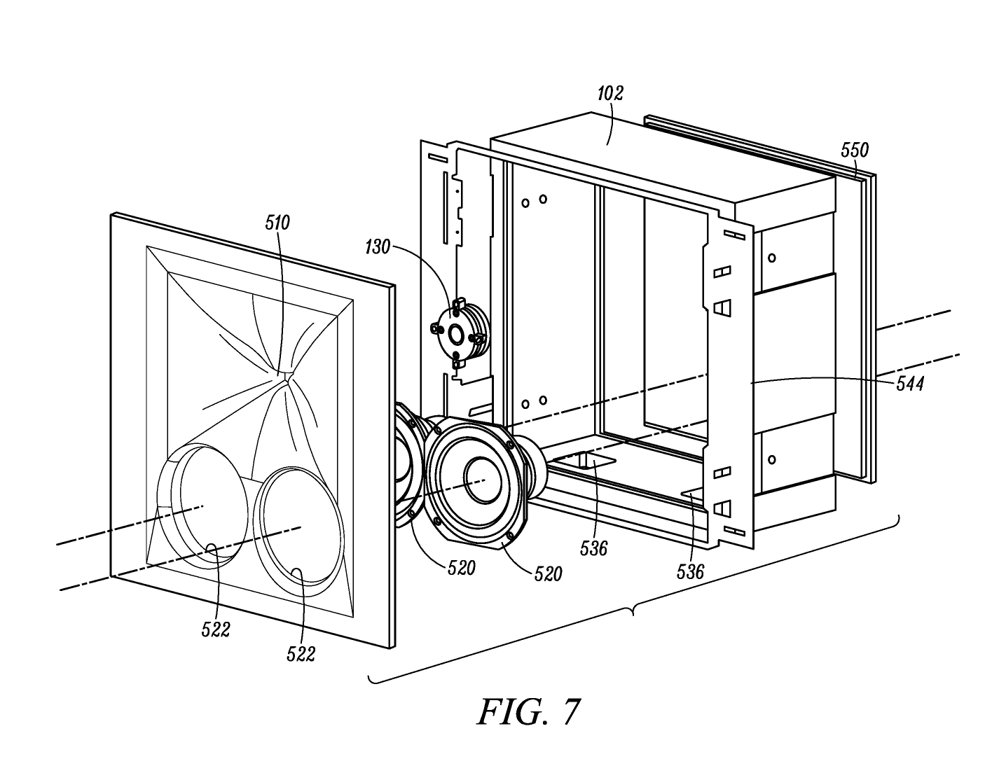

FIGS. 5-7 show another loudspeaker 500 that has similar components as the loudspeaker 100. Similar components are designated by reference numbers that have the same two least significant digits but with the most significant digit changed from “1” to “5.” For brevity, the same components are not described again here. The loudspeaker 500 includes a plurality of speakers 520 below the horn 510. The horn 510 is shaped so that the curve of the horn 510 travels past the speaker apertures 512. The speakers 520 are closely positioned together to vertically align the acoustic center point of the speakers 520 to the mouth of the horn 510. A rear enclosure cover 550 is shown in FIG. 7. The rear enclosure 502 has a plurality of recessed pockets 519 to provide securement points for the front face plate 514 to the rear enclosure 502.

FIGS. 8 and 9 shows the loudspeaker 500 mounted in a wall through a wall board 554 between two frame elements 552. In an example, the frame elements 552 can be wood, e.g., 2×4s, or may be metal framing members. Other engineered products, e.g., laminates or polymers, may be used as the frame elements 552. The frame elements 552 can be spaced at 16 inch or 24 inch intervals. In an example, the loudspeaker 500 may have a first subframe and second subframe between which the wall board 554 is sandwiched.

The horn 510 can have a rectangular outer periphery that is dimensioned to be 200 mm by 300 mm. Smaller dimensions may be used, for example, +/−25 mm or +/−50 mm. The horn 510 depth can be less than 70 mm. In an example, the horn depth is about 63.9 mm, +/−0.2 mm. It will be appreciated that the speaker openings 520 may extend into the horn 510. In an example, the speaker opening, which is circular or ovoid, extends into the horn 510 about 30 mm, +/−5 mm or about 25 mm, +/−5 mm.

In an example, the loudspeakers 100, 500 may be mounted in a wall cavity, e.g., between framing elements 552, without a rear enclosure 102, 502. In such a case the wall cavity may form the rear enclosure 102, 502. The framing elements 552 may form the rear enclosure and additional lateral framing elements 553 may be joined to the longitudinal framing elements 552 to form an enclosure positioned behind the front face plate in which the speaker driver 120 and compression driver 130 are housed. A first subframe 144, 544 may affix to the framing elements 552 and in some embodiments to the lateral framing elements 553. The longitudinal frame elements 552 and the lateral framing elements 553 may act to simulate the rear enclosure 102, 502.

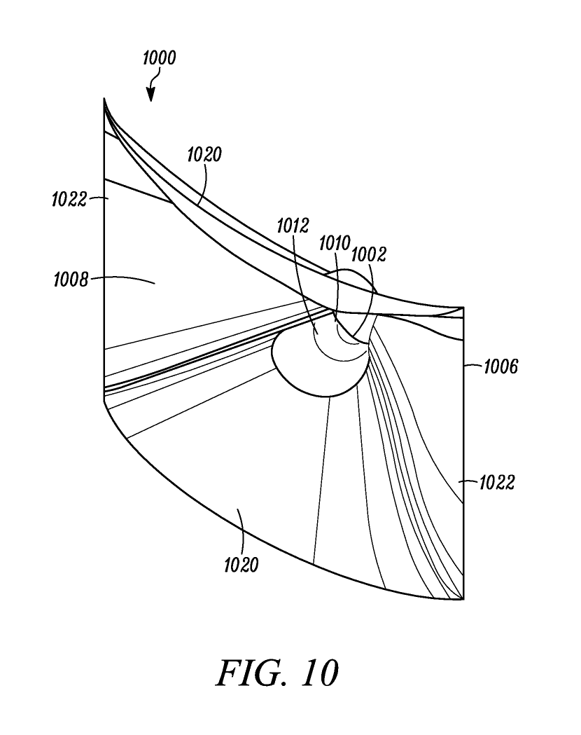

FIG. 10 shows an example of a horn 1000, which may define the coverage angle of a loudspeaker in three or more planes. The horn 1000 includes an entrance 1002 positioned at a first axial end of the horn 1000. The entrance 1002 may be positioned on an entrance plane as described above with reference to the horn 1000. In the example shown in FIG. 10, the entrance 1002 has a circular shape. The horn 1000 includes a mouth 1006 disposed at a second axial end of the horn opposite the entrance 1002. The mouth 1006 may be planar or non-planar. For example, the mouth may be disposed on a plane that is substantially parallel to the entrance plane. Alternatively, the mouth 1006 may be curved as shown in FIG. 10. The mouth 1006 may be disposed on a surface having a radius of curvature about the entrance 1002. In the example shown FIG. 10, the mouth 1006 has a rectangular shape. In other examples, the entrance 1002 and the mouth 1006 may have any other shape. The horn 1000 includes a contoured surface 1008 extending between the entrance 1002 and the mouth 1006. The horn 1000 includes a throat 1010 extending between the entrance 1002 and the contoured surface 1008. The throat 1010 extends from the entrance 1002 to a first axial end 1012 of the contoured surface 1008 to couple the contoured surface and the entrance to one another. The depth of the throat 1010 may vary around the circumference of the throat.

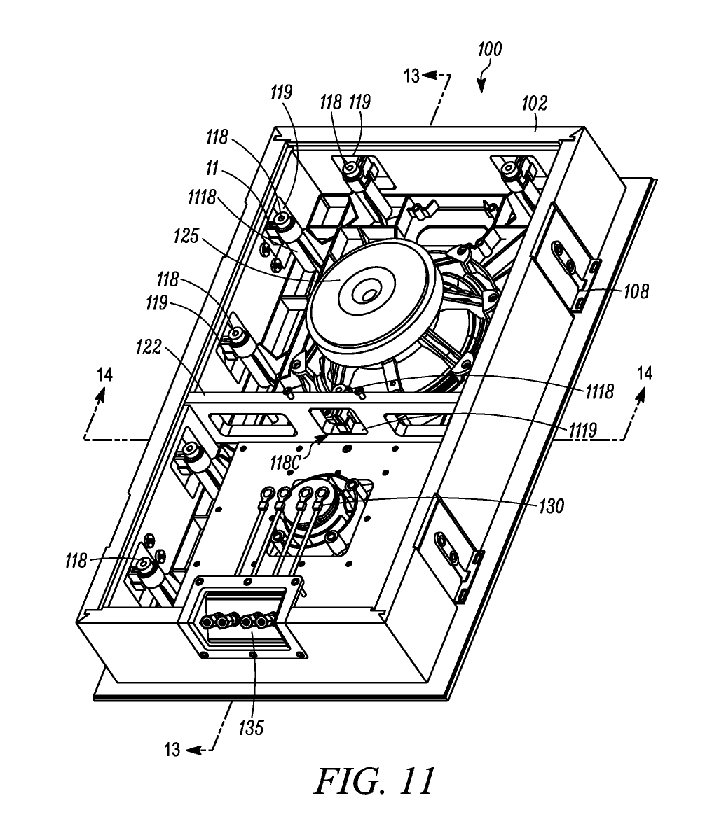

FIG. 11 shows a rear perspective view of a loudspeaker 100 without a back cover. A back cover can be provided or the wall cavity can serve as a back cover. The loudspeaker 100 shows similar elements as described herein with the same reference numbers. The connector legs 118 of the front face plate 104 engage the recesses 119 in the rear enclosure 102. The legs 118 include a first, elongate leg part 1118 that extends rearwardly from the front of the face plate and a foot 1119 connected to the leg part 1118. The leg part 1118 is fixed in place on the front face. The foot 1119 extends radially from the leg part 1118 into the recess 119 to securely engage the enclosure wall that forms the respective recess 119. A reinforcing wall 1121 may extend rearwardly from the front of the face plate around each of the leg parts 1118. The foot 1119 may rotate about the leg part 1118 into engagement with the enclosure wall at the recess 119. This may be a press fit. In another example the foot 1119 is placed on the free end of the cantilevered leg and a connector joins the leg part and the foot while forcing the foot into engagement with the recess wall. In an example, the connector legs 118 are placed around the outer periphery and not directly behind the horn.

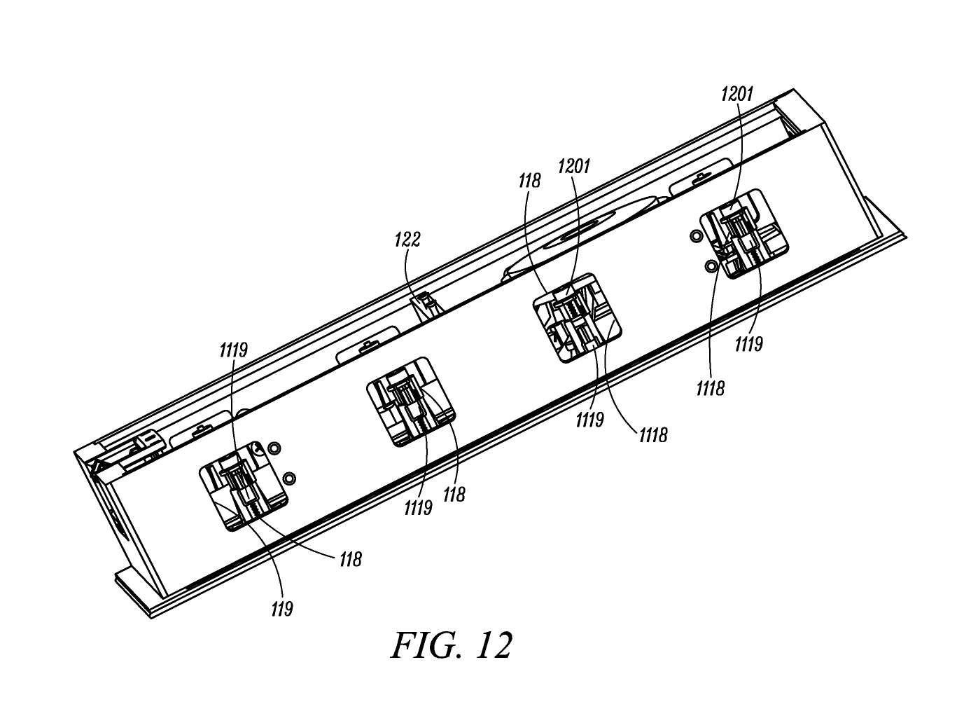

FIG. 12 shows a side view of the loudspeaker with some of the connector 118 engaged with the recess 119 and other not yet engages but aligned with the recess. The second from right connector 118 has its foot 1119 pressed down against the lower wall that forms the recess 119. As shown, the foot is driven downwardly by rotating a threaded connector 1207 that is connected to the leg part 1118. The other examples of the connector 118 have their feet 1119 raised upward from the wall forming the bottom of the recess. The feet 1119 can include a vibration damping component. For example, the foot surface engaging the recess 119 may include rubber or similar damping material. The foot itself can be made from a polymer or rubber that may damp vibrations.

In operation, the vibration dampening feet 1119 and the second subframe 146 acting as a gasket can acoustically isolate the wall, e.g., the wall board 554, from the loudspeaker 100, 500 even though the loudspeaker is mechanically connected to the wall. When the compression driver 130, 530 and the speaker 120, 520 are producing acoustic signals, it is undesirable to have vibrations to pass into the wall structure which may cause sounds that interfere with the sound being broadcast by the loudspeaker 100, 500.

In an example, the foot 1119 has a first part engaging around the leg part 1118 and an internal part that is threadedly engaged with the threaded connector 1201. When the threaded connector 1201 is rotated, then the foot 1119 travels either toward the front of the face plate or away from the front of the face plate. When traveling toward the face plate, the free end of the foot engages the recess 119. A similar connector 118 can engage a recess in the center bracket across the enclosed.

A center connector leg 118C may engage a center recess 119 in the bracket 122. The center connector leg 118 may be closely adjacent the speaker opening 120.

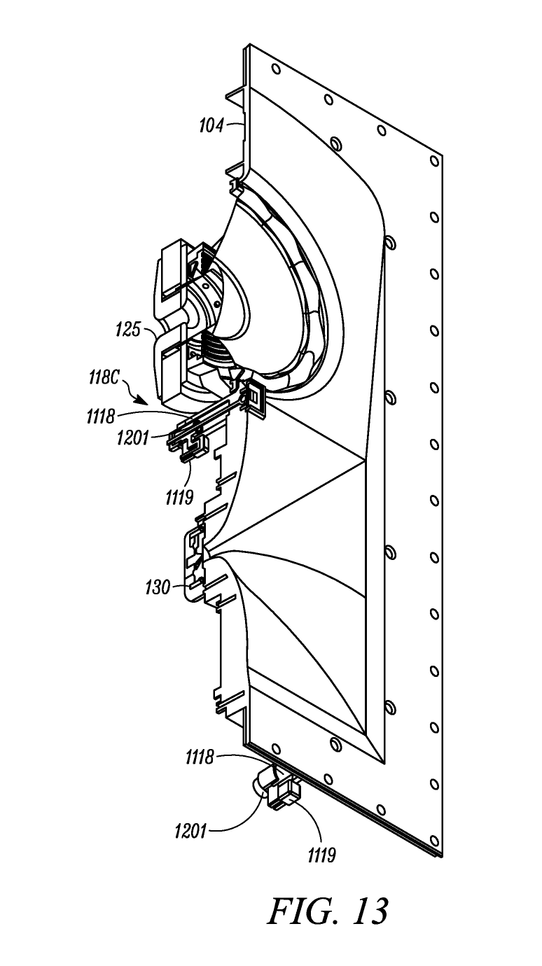

FIG. 13 shows a vertical cross section taken generally along line 13-13 of FIG. 11 to better illustrate the center leg 118C.

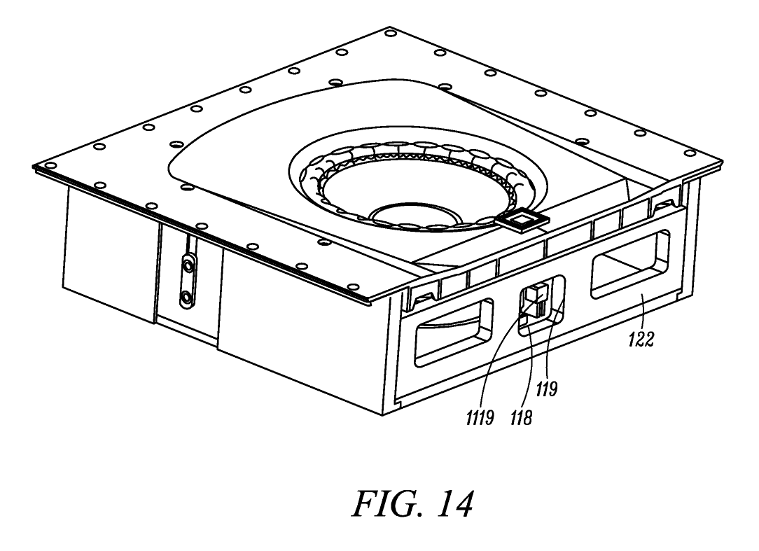

FIG. 14 shows a horizontal cross section taken generally along line 14-14 of FIG. 11 to better illustrate the center leg 118C and the cross bracket 122.

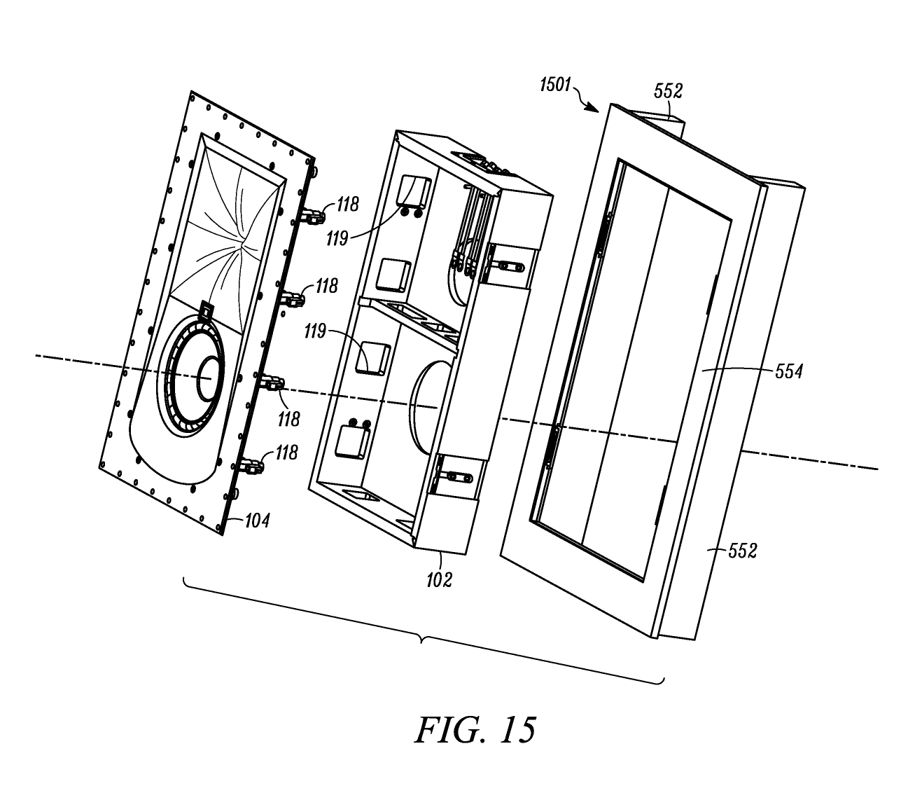

FIG. 15 is an exploded view of a front face plate 104, an enclosure 102 and a wall assembly 1501.

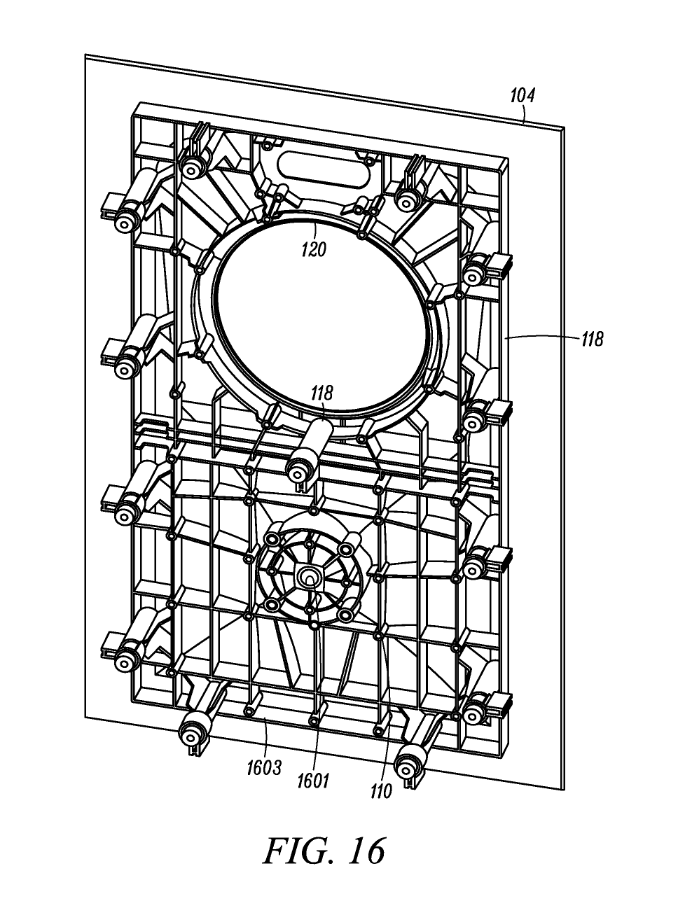

FIG. 16 shows a rear view of the front pace plate 104 without the compression driver or the speaker to more clearly show the feet 118 and the connection areas for both the compression driver and the speaker. The throat 1601 of the horn 110 is shown central to the horn 110. The compression driver connection 1603 is low profile to allow for the shape of the horn and room to mount a compression driver.

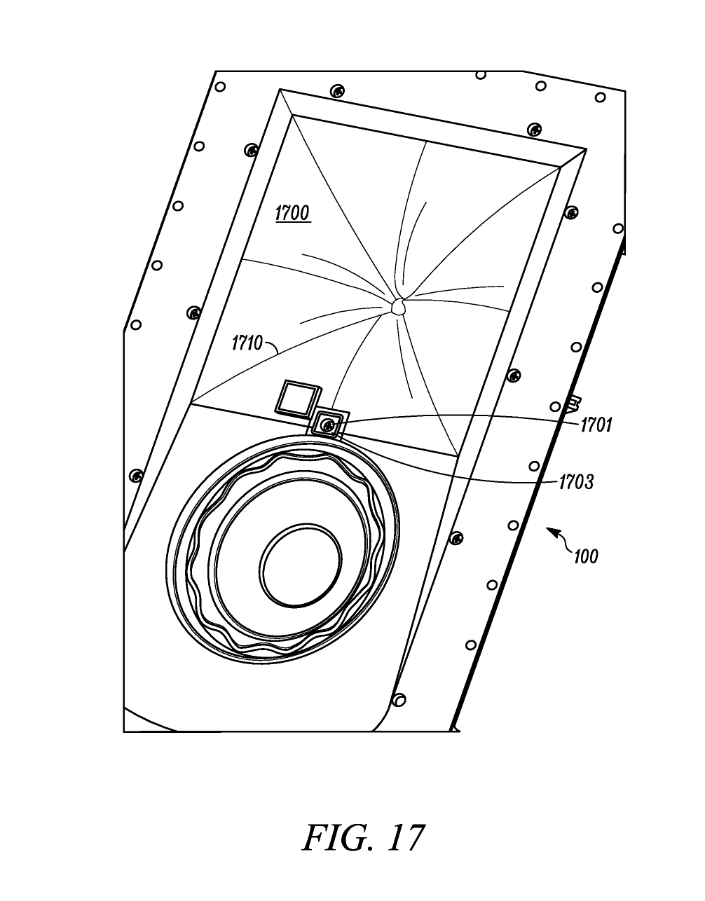

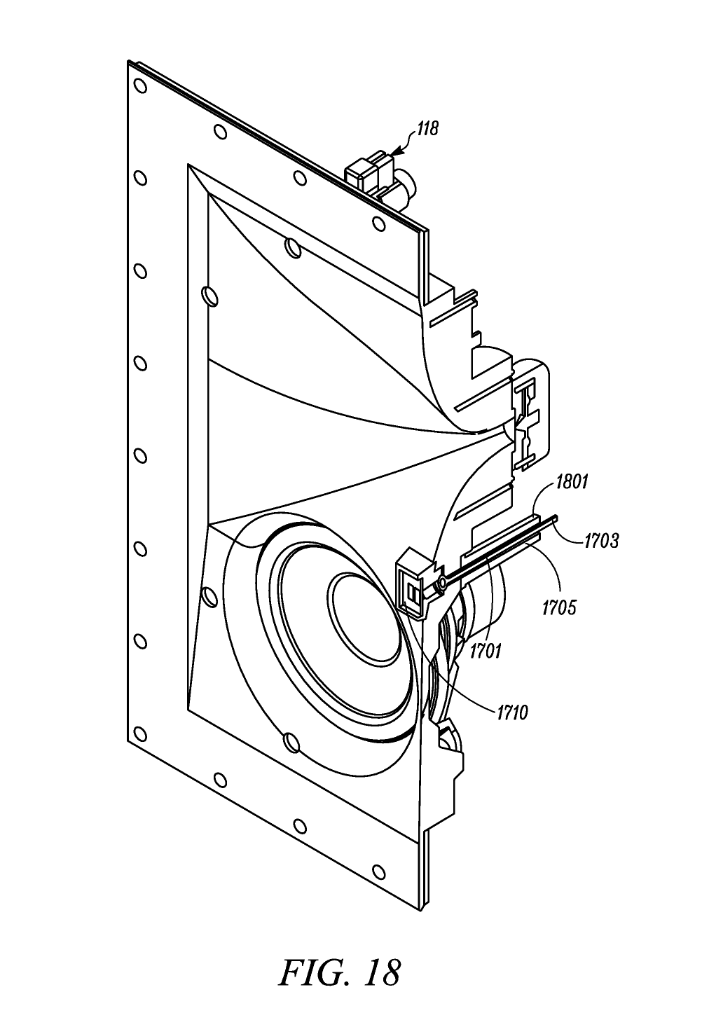

FIGS. 17 and 18 show the loudspeaker 100 (an enlarged front view and a cross sectional view, respectively) with a center connection assembly 1700 with a port 1701 for receiving a fastener 1703. A cover 1710 can be removably fixed to the front face plate 104 to cover the port 1703 and the head of the fastener 1703. The fastener 1703 may be a threaded fastener that engages the wall of a finger 1801 that is fixed to the enclosure 102. The finger 1801 may be fixed to a backwall of the enclosure 102 or to a bracket that extends from the side walls of the enclosure 102.

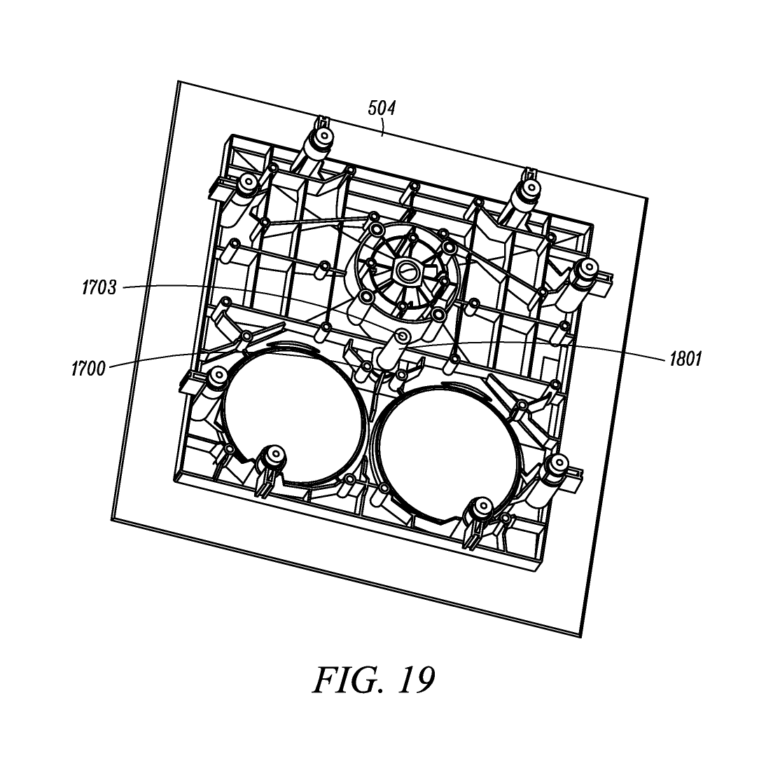

FIG. 19 shows a rear view of a face plate 504 for a loudspeaker 500. A center connection assembly 1700 extends rearwardly from the face plate 504 with the fastener 1703 in the finger 1801. The fastener

While the center connector leg 118C is illustrated and described with respect to loudspeaker 100, it is within the scope of the present disclosure to provide the center connector leg structure in the loudspeaker 500.

The loudspeakers 100, 500 can provide constant directivity resulting in even timbre throughout the room, e.g., with no sound “coloration”. The loudspeakers 100, 500 can provide high dynamic SPL for lifelike sound levels without distortion. The loudspeakers 100, 500 can also provide the present improvements without equalization even to 10 kHz and beyond.

The depth of the loudspeakers 100, 500 is shallow and will fit in a USA standard 4″ wall or other standard wall depth in Europe, Asia, or China. The loudspeakers 100, 500 have a small footprint and can be surface-mounted to a wall. Unlike other surface-mount speakers, the loudspeakers 100, 500 include a compression driver 130 and a matched acoustic loading horn 110, 510. Surface-mount loudspeakers with a compression driver provide improved performance.

While shown in an orientation with the horn above the speaker, it will be within the scope of the present disclosure to invert the loudspeaker 100, 500 to place the speaker 120 above the horn 110, or rotate the loudspeaker to its left or right sides. The loudspeaker 100, 500 can also be mounted in a ceiling with neither the horn 110 nor the speaker 120 being above the other.

While not shown, the loudspeakers 100, 500 may be covered by a zero-bezel, magnetically-attached grille. Such a grille may extend outside the wall.

A loudspeaker includes a horn and a compression driver in a shallow package for installation in a wall, e.g., a four inch wide wall. The total depth for this loudspeaker may be about 3 and ¾ inches (about 90 mm). An entrance is disposed at a first axial end of the horn and is configured to receive input from the driver. A mouth may be disposed at a second axial end of the horn opposite the entrance. A contoured surface may extend between the entrance and the mouth. A cross sectional shape of a coverage pattern of audible sound emitted by the loudspeaker coupled with the horn may be independent of a shape of the entrance and a shape of the mouth.

The loudspeakers described herein have a small format and can be flush-mounted to a wall, e.g., a wall internal to a building or a house. Such walls may be fabricated using 2×4 boards or similar sized metal or polymer structures. The loudspeakers may include integrated enclosures that form the horn and allow for flexible applications including in-wall surround, in-wall left center right channel (LCR), and an in-ceiling overhead channel.

The horn 110, 510 can be a horn as described in U.S. patent application Ser. No. 14/371,162, published as 2015/0014089, which is hereby incorporated by reference for any purpose.

The present loudspeaker uses a loudspeaker to handle the lower frequencies and a horn acoustically loading a compression driver, which can provide a sound pressure level in the room that has off-axis measurements that have common characteristics with the on-axis frequency response. The use of a compression driver, e.g., a compression transducer, uses a sound producer that is more efficient in converting electro-mechanical energy to acoustic output than conventionally used direct radiating tweeters. The present loudspeaker is much more responsive to transients in music than direct-radiating tweeters.

An in-wall mountable loudspeaker having a horn matched to a compression driver and a speaker may be claimed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A loudspeaker comprising:
a frame dimensioned to be mounted in a wall with a front face being flush mounted to the wall;
a speaker supported by the frame and dimensioned to be mounted in a wall;
a horn supported by the frame positioned by the speaker; and
a compression driver supported by the frame and acoustically connected to the horn;
wherein the horn acoustically loads the compression driver to provide a high dynamic output and a high sound pressure level with controlled acoustic directivity.

2. The loudspeaker of claim 1, wherein the horn is configured to provide a constantly controlled timbre and a uniform sound pressure level in a room at least partially defined by the wall in which the frame is mounted with the horn and the speaker acoustically facing outwardly into the room.

3. The loudspeaker of claim 1, wherein the speaker is a woofer to broadcast low frequencies, wherein the horn and compression driver broadcast non-low frequencies without equalization of the low frequencies.

4. The loudspeaker of claim 1, wherein the frame and horn have a depth less than a depth of the wall in which the frame is mounted.

5. The loudspeaker of claim 1, wherein the frame includes a brace extending from a first side of the frame to a second side of the frame between the speaker and the horn.

6. The loudspeaker of claim 5, wherein the brace includes apertures therein acoustically joining a first frame volume adjacent the speaker and a second frame volume adjacent the horn and the compression driver.

7. The loudspeaker of claim 1, wherein the frame includes a rear subframe to close a rear of the frame, an intermediate subframe connected to the rear subframe and a front subframe connected to the intermediate subframe, wherein the horn is on the front subframe and extends rearwardly within the intermediate subframe and ends before the rear subframe.

8. The loudspeaker of claim 1, wherein the front face of the frame includes an aperture at which the speaker is mounted to provide an acoustical path out of the loudspeaker, and wherein the horn extends partially past the aperture.

9. The loudspeaker of claim 8, wherein the horn includes a curved surface that extends past the aperture.

10. The loudspeaker of claim 1, wherein the horn includes a rectangular periphery.

11. A wall mountable loudspeaker comprising:
a frame dimensioned to be mounted in a wall with a front face being flush mounted to the wall;
a first speaker supported by the frame and dimensioned to be mounted in a wall;
a second speaker supported by the frame and dimensioned to be mounted in a wall, the second speaker being positioned laterally aligned;
a horn supported by the frame positioned longitudinally by the first speaker and the second speaker; and
a compression driver supported by the frame and acoustically connected to the horn;
wherein the horn acoustically loads the compression driver to provide a high dynamic output and a high sound pressure level with controlled acoustic directivity, and
wherein the horn is configured to provide a constantly controlled timbre and a uniform sound pressure level in a room at least partially defined by the wall in which the frame is mounted with the horn, the first speaker and the second speaker acoustically facing outwardly into the room.

12. The loudspeaker of claim 11, wherein the first speaker and the second speaker are tilted radially outwardly from each other.

13. The loudspeaker of claim 12, wherein the horn faces directly outwardly from the front face of the frame.

14. The loudspeaker of claim 12, wherein the horn is configured to direct sound above about 1 kHz.

15. The loudspeaker of claim 11, wherein the frame and the horn have a combined depth less than a depth of the wall in which the frame is mounted.

16. The loudspeaker of claim 11, wherein the frame includes a brace extending from a first side of the frame to a second side of the frame between the horn and the first and second speakers.

17. The loudspeaker of claim 11, wherein front face includes a first aperture aligned with the first speaker and a second aperture aligned with the second speaker to provide acoustically access through the front face, and wherein the horn includes a side that extends at least partially past the first aperture and the second aperture.

18. The loudspeaker of claim 11, wherein the horn includes a rectangular periphery defined by a curved surface with a portion of the rectangular periphery extending through the first aperture and the second aperture.

19. The loudspeaker of claim 11, wherein the front face of the frame includes a center port to receive a fastener to fix the frame in a wall, the center port being positioned between the horn, the first speaker and the second speaker.

20. The loudspeaker of claim 11, wherein the horn and the frame are integrally formed.
